(19) United States
(12) Patent Application Publication
(10) Pub. No.: US 2014/0117845 A1
(43) Pub. Date: May 1, 2014

(54) IGNITION AID AND LAMP COMPRISED THEREOF

(71) Applicant: GE HUNGARY KFT., Budapest (HU)

(72) Inventors: Tamas PANYIK, Budapest (HU); Zoltan JANKI, Budapest (HU); Gabor TOROS, Budapest (HU)

(73) Assignee: GE HUNGARY KFT., Budapest (HU)

(21) Appl. No.: 13/666,110

(22) Filed: Nov. 1, 2012

(51) Int. Cl. H01J 7/30; H01J 61/54

(52) U.S. Cl. 313/607; 313/234

(57) ABSTRACT

Embodiments of a lamp comprise an arctube and an ignition aid that couples with the arctube to allow discharge to occur at lower breakdown voltages and without the need for radioactive material (e.g., Kr⁸⁵). The ignition aid has an elongated body that extends in parallel relation to the arctube. One or more extension members extend from the elongated body to contact the arctube. In one example, the extension members include a pair of contacts, which couple with the arctube to provide both electrical connectivity and mechanical support.

### BACKGROUND

The subject matter of the present disclosure relates to lamps and lighting devices and, in particular, to high-intensity discharge (HID) lamps that include an ignition aid to improve starting performance.

High-intensity discharge (HID) lamps initiate a discharge between two conductors that are given opposite electric potential. To facilitate the discharge, conventional lamps employ a source of free electrons. This source lowers the ignition voltage (also “breakdown voltage”) the lamp requires to initiate the discharge. Examples of the electron source include radioactive material, e.g., Kr⁸⁵ gas, that mixes with the fill gas. Use of radioactive material reduces the need to provide very high electric potential on the conductors, which makes the external electrical circuitry (e.g., the ballast) and systems design simpler and more cost effective. However, government regulations limit, and in some cases eliminate, the amount of radioactive Kr⁸⁵ that can be used in HID lamps.

### BRIEF DESCRIPTION OF THE INVENTION

The discussion below describes embodiments of an ignition aid that permits lamps, e.g., HID lamps, to initiate a discharge without radioactive materials in the fill gas. These embodiments generate free electrons and a charge channel within proximity of the arctube. These features create conditions in which the discharge can more easily form, which facilitates ignition and, more particularly, can improve ignition performance during cold ignition, hot-strike ignition, and other ignition. Moreover, the proposed design also provides structure that provides mechanical support to the arctube.

This disclosure describes, in one embodiment, a lamp that comprises an arctube having a longitudinal axis, a discharge element with an outer surface, and a first leg element extending from the discharge element along the longitudinal axis. The lamp also comprises a plurality of electrodes comprising a first electrode and a second electrode extending into the arctube and an electrically-conductive frame element coupled with at least one of the first electrode and the second electrode. The lamp further comprises an electrically-conductive ignition aid coupled with the electrically-conductive frame element, the electrically-conductive ignition aid comprising a first extension member in contact with the first leg element and having an inner peripheral edge proximate the outer surface of the discharge element and extending in a direction along the longitudinal axis, wherein the peripheral edge is spaced radially apart from the longitudinal axis to form a gap with the outer surface of the discharge element.

This disclosure also describes, in one embodiment, a high-intensity discharge lamp that comprises an electrically-insulating arctube comprising light transmitting material. The electrically insulating arctube having a longitudinal axis and a discharge element with a first leg element and a second leg element extending on opposite sides of the discharge element. The high-intensity discharge lamp also comprises a plurality of electrodes comprising a first electrode and a second electrode extending into, respectively, the first leg element and the second leg element and an electrically-conductive frame element coupled with at least one of the first electrode and the second electrode. The high-intensity discharge lamp further comprises an electrically-conductive ignition aid coupled to the electrically-conductive frame element, the ignition aid comprising an elongated body member and a first extension member and a second extension member extending from the elongated body member toward the longitudinal axis to contact the arctube at, respectively, the first leg element and the second leg element, the elongated body member having a peripheral edge extending in a direction along the longitudinal axis, wherein the peripheral edge is spaced radially apart from the longitudinal axis to form a gap between the peripheral edge and a surface of the arctube.

This disclosure further describes, in one embodiment, an ignition aid for a high-intensity discharge lamp. The ignition aid comprises an electrically-conductive metal foil comprising an elongated body member having an outer peripheral edge, an inner peripheral edge, and a first extension member forming a first edge extending from a first end of the peripheral edge. The first extension member comprises a first contact and a second contact having resilient properties, wherein the first contact and the second contact have a first position proximate a plane disposed on a surface of the electrically-conductive metal foil and a second position spaced apart from the plane and at which the first contact and the second contact can generate a clamping force.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 depicts a side, schematic view of an exemplary embodiment of an ignition aid;

FIG. 2 depicts a schematic view of a side, partial cross-section of an exemplary embodiment of a lamp that incorporates an ignition aid, e.g., the ignition aid of FIG. 1;

FIG. 3 depicts a schematic view of a side of the lamp of FIG. 2;

FIG. 4 depicts a side, perspective view of another example of a lamp that incorporates an ignition aid, e.g., the ignition aid of FIG. 1;

FIG. 5 depicts a detail view of the lamp of FIG. 4;

FIG. 6 depicts a cross-section view of the lamp of FIGS. 4 and 5; and

FIG. 7 depicts a side, perspective view of another exemplary embodiment of an ignition aid; and

FIG. 8 illustrates a plot of breakdown voltage (kV) as applied to an exemplary embodiment of a lamp during ignition testing at −30° C.

Where applicable like reference characters designate identical or corresponding components and units throughout the several views, which are not to scale unless otherwise indicated.

### DETAILED DESCRIPTION OF THE INVENTION

Broadly, the present disclosure describes an ignition aid that can improve starting performance, e.g, of high-intensity discharge (HID) lamps. During ignition of HID lamps, the ignition aid provides free electrons and develops a charge tunnel proximate the outer surface of the discharge element. These features lower the breakdown voltage necessary to ignite an arc. Use of the ignition aid of the present disclosure can eliminate the need to supplement the fill gas with radioactive material (e.g., Kr⁸⁵) in order to achieve ignition during certain conditions (e.g., cold ambient temperature) and installations, e.g., where long wiring connections conduct signals between the lamp and the power source. Moreover, the ignition aid can also improve hot restrike or starting by lowering the ignition voltage required when the lamp is at operating temperature.

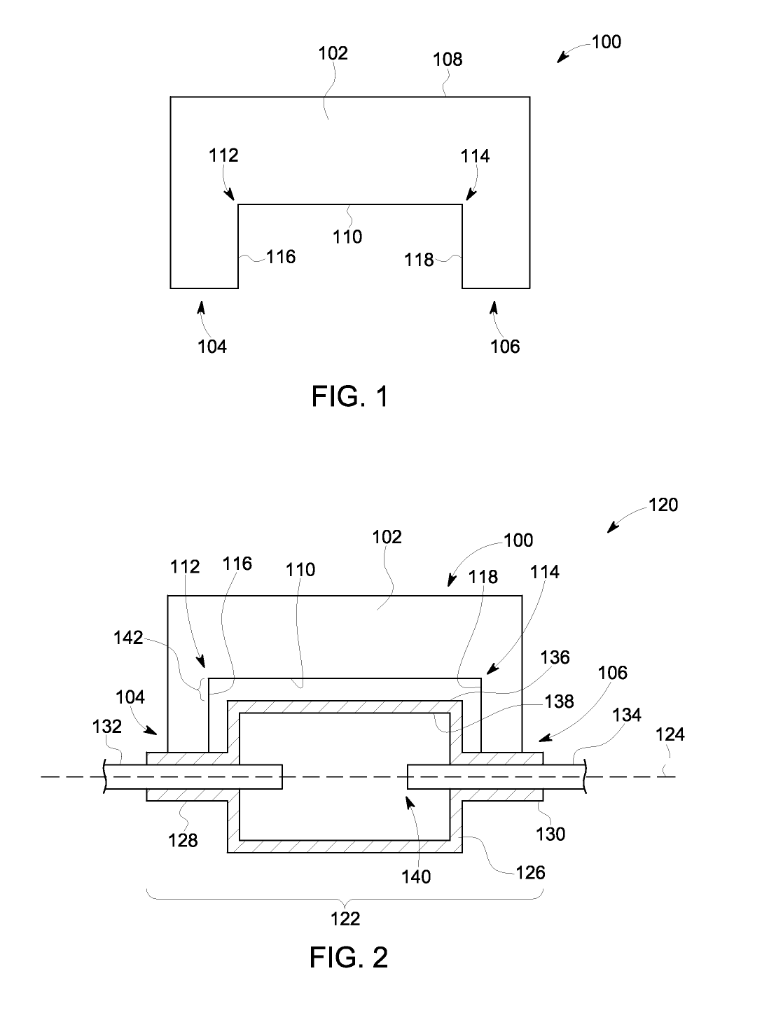

FIG. 1 illustrates an exemplary embodiment of an ignition aid 100. In this example, the ignition aid 100 has an elongated base member 102 and one or more extension members (e.g., a first extension member 104 and a second extension member 106). The elongated base member 102 has an outer peripheral edge 108 and an inner peripheral edge 110 with a first end 112 and a second end 114. The extension members 104, 106 form a first inner edge 116 and a second inner edge 118 that terminate at, respectively, the first end 112 and the second end 114.

FIG. 2 illustrates the ignition aid 100 as part of a lamp 120, e.g., a ceramic metal halide (CMH) lamp and/or similar HID lamp. Examples of the lamp 120 are favored for use in many applications (e.g., use as automotive headlamps) over incandescent and fluorescent lamps because the lamp 120 can generate more light per unit of electric power consumed. In one example, the lamp 120 includes an arctube 122 with a longitudinal axis 124, a discharge element 126, and a pair of leg elements (e.g., a first leg element 128 and a second leg element 130) extending therefrom. The leg elements 128, 130 receive an electrode (e.g., a first electrode 132 and a second electrode 134). Examples of the discharge element 126 and leg elements 128, 130 can comprise light transmitting materials, e.g., polycrystalline alumina and similar ceramics materials. In one example, the discharge element 126 has an outer surface 136 and an inner surface 138 that forms the periphery of an ignition cavity 140, which contains a fill gas or other ionizable material including an inert gas (e.g., argon), metal halide, and mercury. The inner peripheral edge 110 is spaced apart from the outer surface 136 of the discharge element 126 to form a gap 142.

As shown in the example of FIG. 2, the electrodes 132, 134 extend into the ignition cavity 140. This configuration allows the electrodes 132, 134 to conduct an electrical signal into the ignition cavity 140. The electrical signal forms an arc between the electrodes 132, 134. The arc excites the fill gas in the discharge element 126 to generate light.

Examples of the ignition aid 100 improve starting ignition (e.g., reduces breakdown voltage, improves cold and hot start capabilities, etc.) of the lamp 120 and also reduce and/or eliminate the need to include radioactive material (e.g., Kr⁸⁵) in the ignition cavity 140. For example, proximity of the extension members 104, 106 to the electrodes 132, 134 generates a high density electrostatic field that promotes ignition of the arc. Forming the ignition aid 100 to minimize the size of the gap 142 positions the inner peripheral edge 110 to cause a charge channel to form along the inner surface 138 of the ignition cavity 140. This charge channel helps to concentrate and guide the arc during ignition. Further, contact between one or more of the extension members 104, 106 and the arctube 122 helps to initiate a capacitively coupled discharge that generates a large amount of free electrons inside of the discharge element 126. These free electrons are sufficient to facilitate ignition of the arc in lieu of free electrons that are no longer available in the absence of radioactive material in the ignition cavity 140.

The gap 142 can extend in a direction along the longitudinal axis 124, defining the distance between the inner peripheral edge 110 and the outer surface 136. This distance can be from about 0.1 mm to about 1 mm. In one example, the distance is constant, e.g., the spacing between the peripheral edge 110 and the outer surface 136 remains the same and/or within limited tolerances (e.g., ±0.1 mm) from the first end 112 to the second end 114 of the peripheral edge 110. However, the distance can also vary in the direction along the longitudinal axis 124, e.g., in relation to the shape and contour of the inner peripheral end 110 and/or the outer surface 136 of the discharge element 126. For example, the outer surface 136 may have a concave and/or convex curvature that causes the gap 142 to increase and decrease from the first end 112 to the second end 114 of the peripheral edge 110.

Examples of the ignition aid 100 can assume a variety of form factors. Generally, these form factors take shapes and sizes that facilitate the ignition process and that can fit within the housings and other construction elements typical of the lamp 120. As shown in FIGS. 1 and 2, the shape of extension members 104, 106 can be square and/or rectangular, wherein the first inner edge 116 and the second inner edge 118 are parallel to one another. The configuration allows the ignition aid 100 to fit about the discharge element 126.

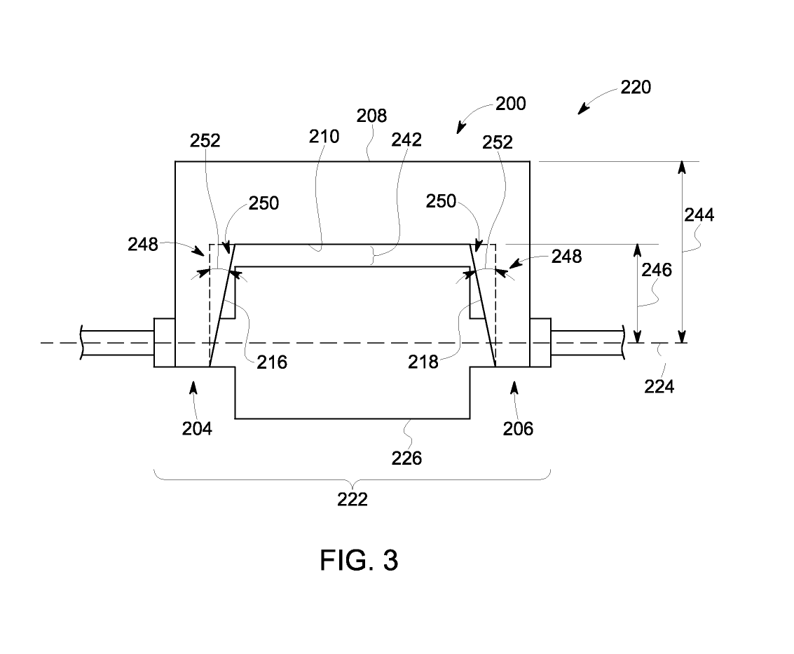

FIG. 3 depicts another exemplary embodiment of an ignition aid 200 as part of a lamp 220 to illustrate other variations in the form factor. In the example of FIG. 3, an outer dimension 244 and an inner dimension 246 define the location of, respectively, the outer peripheral edge 208 and the inner peripheral edge 210 relative to the longitudinal axis 224. This example also shows the inner edges 216, 218 in a first position, identified by phantom lines and the numeral 248, and a second position 250. An angular offset 252 defines the change in position of the inner edges 216, 218.

Collectively, combinations of the outer dimension 244, the inner dimension 246, and the angular offset 252 can define the form factor of the ignition aid 200. In one example, these dimensions are useful to define, and in many cases to maintain, the size of the gap 242 for various shapes and sizes of the arctube 222. As mentioned above, the outer dimension 244 is sized and configured to allow the ignition aid 200 to fit within the existing lamp structure. Variations in the inner dimension 246 can move the inner peripheral edge 210 relative to the discharge element 226, thereby increasing and decreasing the gap 242. Moreover, the angular offset 252 can vary, e.g., between 0° and 60°. Although shown as uniform on both the first extension member 204 and the second extension member 206, the angular offset 252 can be different as necessary. For example, selection of the appropriate angular offset 242, as well as the other dimensions, may be based on features of the arctube 222 including the shape of the discharge element 226.

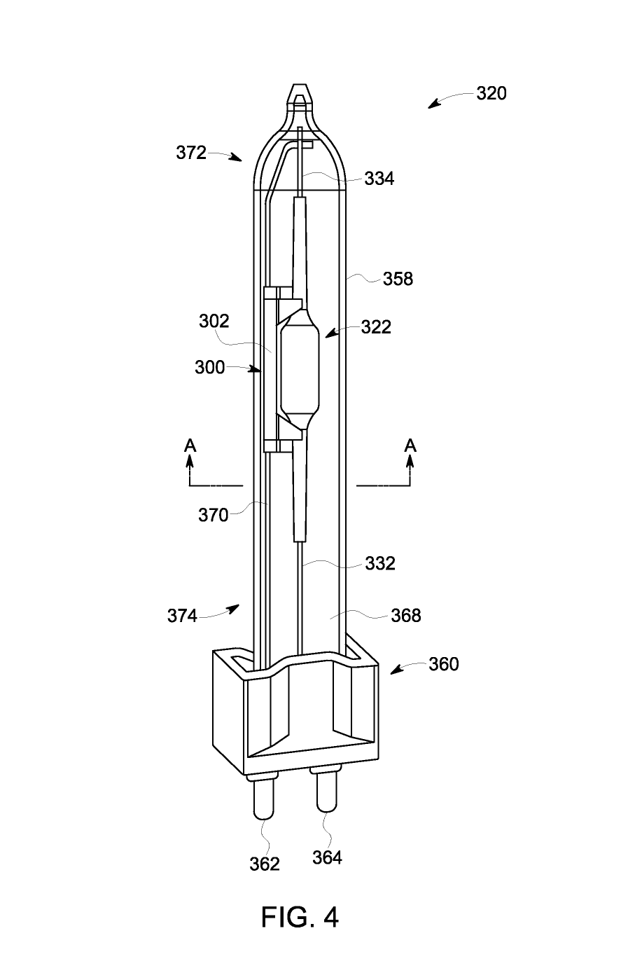

FIGS. 4, 5, and 6 depict another exemplary embodiment of an ignition aid 300, which is shown as part of a lamp 320. In one example, the lamp 320 has an outer jacket 358 and a socket 360 with a pair of connectors (e.g., a first connector 362 and a second connector 364). The outer jacket 358 forms a hermetically-sealed cavity 368 around the ignition aid 300 and the arctube 322. The hermetically-sealed cavity 368 forms a vacuum therein to avoid thermal losses and breakdown outside of the arctube 322.

The lamp 320 also includes structural elements to secure the arctube 322 within the cavity 368. In one example, the lamp 320 has a frame element 370 with a first frame end 372 and a second frame end 374, which secures to the arctube 322, e.g., to the second electrode 334. The frame element 370 can comprise electrically-conductive material, e.g., metals in the form of rigid wire. This rigid wire can prevent movement of the arctube 322. In one embodiment, the first electrode 332 and the first frame end 372 couple with the connectors 362, 364 to conduct the electrical signal (e.g., current, voltage, etc.) to the arctube 322 to generate the arc.

Examples of the ignition aid 300 can secure to a portion of the frame element 370. Fasteners in the form of welds, adhesives, and like elements can promote effective attachment of the ignition aid 300 and the frame element 370. These fasteners can reside and/or be disposed on the frame element 370 and the elongated base member 302. In other examples, one or more pieces of the ignition aid 300 can be formed integrally with the frame element 370. In still other constructions, the lamp 320 may include one or more intermediary pieces (e.g., clips) that secure and position the ignition aid 300 on the frame element 370. Such construction contemplates pieces that are integral with the frame element 370 and/or the ignition aid 300, as well as pieces separately formed that connect, couple, and secure to the ignition aid 300 and the frame element 370.

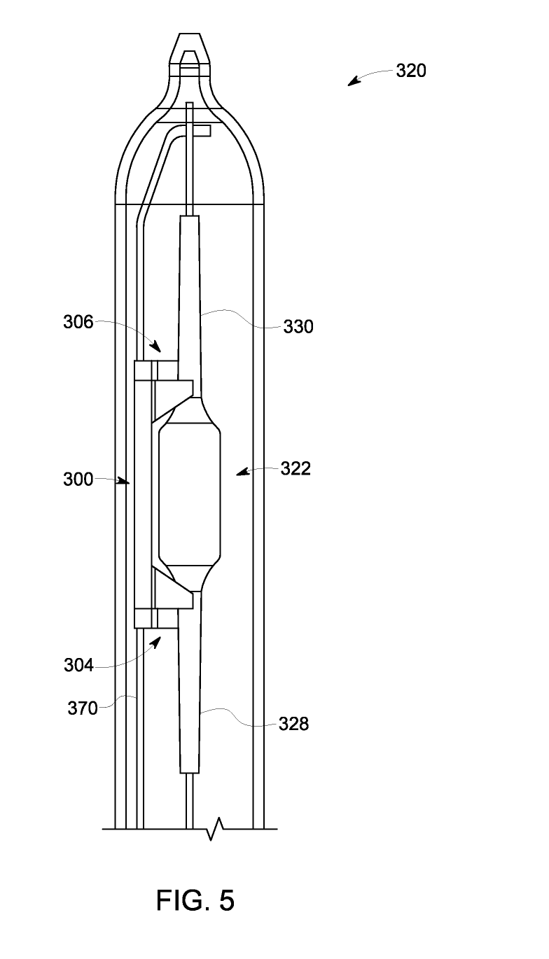

As best shown in FIG. 5, when in position on the frame element 370, the ignition aid 300 also provides mechanical support to the arctube 322. For example, the extension members 304, 306 can couple with the corresponding leg elements 328, 330 to prevent movement of the arctube 322. The present disclosure contemplates configurations in which one or more of the extension members 304, 306 secure to the leg elements 328, 330 (e.g., via weld and/or adhesive). However, in one embodiment, the extension members 304, 306 do not fasten to the leg elements 328, 330. For example, construction of the extension members 304, 306 can apply a clamping force onto one or more contact areas of the outer surface of the leg elements 328, 330.

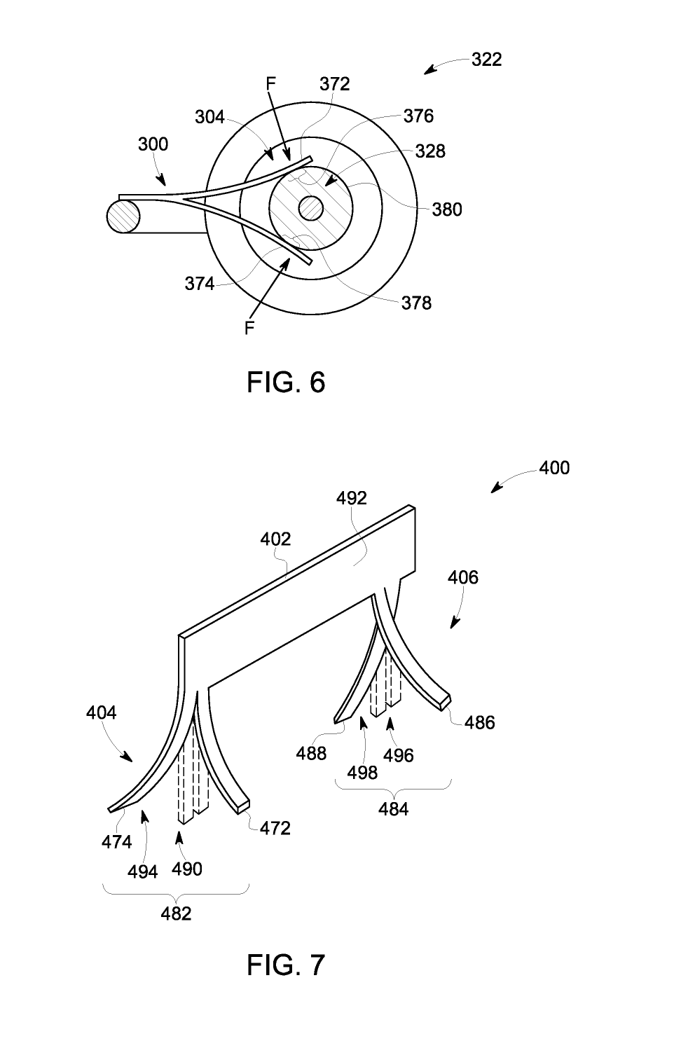

To illustrate and describe this clamping feature, FIG. 6 shows a cross-section of the lamp 322 taken at line A-A of FIG. 4. In the example of FIG. 6, the extension member 304 includes one or more contacts (e.g., a first contact 372 and a second contact 374) that form contact areas (e.g., a first contact area 376 and a second contact area 378) with an outer surface 380 of the leg element 328. In one embodiment, the first contact 372 and the second contact 374 apply a clamping force F onto the outer surface 380. This clamping force F couples the first contact 372 and the second contact 374 with the outer surface 380. This configuration can also mechanically secure the arctube 322, as set forth above. Moreover, the clamping force F promotes electrical connectivity and/or coupling between the contacts 372, 374 and the outer surface 380 of the leg element 328.

Multiple contact areas may correspond to opposite sides of the leg element 328. Examples of the contact areas are small enough so the extension member 304 does not disrupt ignition nor does the clamping force cause damage to the arctube 322. In one example, the contact area occurs at a portion of the leg element 328 that has a temperature that is relatively lower than the temperature at other portions of the leg element 328. In one example, a material layer may be disposed on one or more of the leg element 328 (e.g., on the outer surface 380). This material layer can comprise material (or “conductive material”) that conducts electrical signals, charge, and the like to promote conduction between the ignition aid 300 and part of the leg elements 328. The conductive layer increases the surface area of the leg element 328 that has the electric potential of the ignition aid 300.

FIG. 7 illustrates another exemplary embodiment of an ignition aid 400 for use in HID lamps (e.g., lamp 120, 220, and 320 of FIGS. 2, 3, 4, 5, and 6). The ignition aid 400 includes an elongated body member 402 with a pair of extension members (e.g., a first extension member 404 and a second extension member 406). In one example, the extension members 404, 406 include a pair of contacts (e.g., a first pair 482 and a second pair 484). The first pair 482 include the first contact 472 and the second contact 474 and the second pair 484 include a third contact 486 and a fourth contact 488. Examples of the contacts 472, 474, 486, 488 can have resilient properties (e.g., flexibility) that permit the contacts to assume a plurality of positions, one or more of which can cause the contacts 472, 474, 486, 488 to generate the clamping force F (FIG. 6).

As shown in FIG. 7, the first contact 472 and the second contact 474 can have a first position 490 proximate a plane that is disposed on and/or is coplanar with a surface 492 of the elongated body member 402. The first contact 472 and the second contact 474 can also have a second position 494 at which the first contact 476 and/or the second contact 478 can generate the clamping force F (FIG. 6). In one example, the third contact 486 and the fourth contact 488 can have a third position 496, proximate the plane, and a fourth position 498 at which the third contact 486 and/or the fourth contact 488 can generate the clamping force F (FIG. 6). Although shown with a certain form factor (e.g., rectangular), artisans with skill in the relevant lighting arts will understand from the discussion in this disclosure the various form factors for the components of the ignition aid 400 to achieve one or more of the benefits disclosed herein.

Examples of the ignition aid 400 can utilize thin foils and, in one example, electrically-conductive metal foil having a thickness from about 0.01 mm to about 0.15 mm. These thin foils can comprise high melting point metals, e.g. metals with a melting point of 500° C. or greater. Exemplary metals can comprise niobium, molybdenum, tantalum, platinum, rhenium, tungsten, nickel, and combinations, compositions, and derivations thereof. Foils of this type can impart certain physical properties, e.g., flexibility and/or resilience, to allow the contacts 476, 478, 480, 482 to generate the clamping force F (FIG. 6) as discussed above.

Components of the ignition aid 400 can be formed monolithically, e.g., out of a single material blank of metal foil that is manipulated (e.g., by stamping, cutting, machining, etc.) to the form factor as desired. In other examples, the ignition aid 400 can comprise a number of components and/or pieces, which are assembled together using known techniques and fasteners (e.g., adhesives, welds, etc.).

### EXPERIMENTAL EXAMPLES

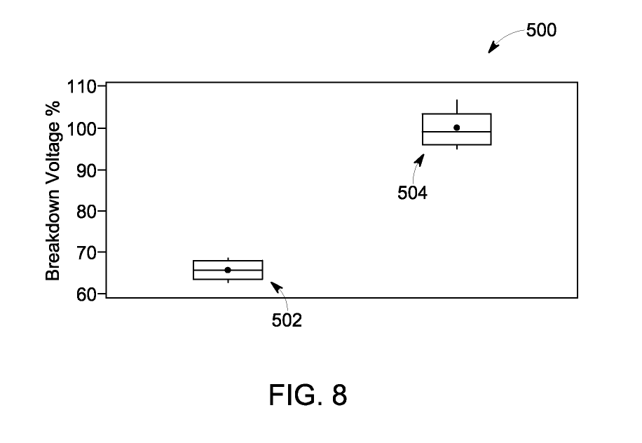

FIG. 8 illustrates test data for an exemplary lamp that includes an exemplary embodiment of an ignition aid with one or more features this disclosure describes above for ignition aids 100, 200, 300, and 400 of FIGS. 1, 2, 3, 4, 5, 6, and 7. The data illustrates the improvements in performance of lamps that include the proposed ignition aid as compared to conventional lamps without any ignition aid. The data compiled herein is for purposes of example only and does not emphasize any one configuration or feature of lamps that fall with the scope and spirit of the discussion herein.

FIG. 8 illustrates a plot 500 of breakdown voltage (kV) as applied to various devices during ignition testing at −30° C. In this example, lamps of varying configurations were subject to increasing voltage at a rate of 1 kV/100 msec. The plot 500 shows breakdown voltage for a lamp 502 that uses an example of an ignition aid (e.g., ignition aides 100, 200, 300, 400 of FIGS. 1, 2, 3, 4, 5, 6, and 7). The plot 500 also shows breakdown voltage for a comparative lamp 504 that does not include an ignition aid or radioactive material. The comparative lamp 504 is used as a baseline, and thus uses 100% of the necessary breakdown voltage. As shown in FIG. 8, the lamp 502 that includes the exemplary ignition aid requires a fraction of the necessary breakdown voltage for the comparative lamp 504.

In view of the foregoing Experimental Results, and the earlier discussion of the exemplary embodiments of the ignition aid above, exemplary ignition aids of this disclosure improve starting performance of lamps while forgoing use of radioactive material to achieve discharge. These ignition aids afford the lamp with sufficient free electrons, as well as other features, to require lower breakdown voltage and to provide other enhancements that are superior to existing, conventional ignition aid and lamp technology.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose embodiments of the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A lamp, comprising:
an arctube having a longitudinal axis, a discharge element with an outer surface, and a first leg element extending from the discharge element along the longitudinal axis;
a plurality of electrodes comprising a first electrode and a second electrode extending into the arctube;
an electrically-conductive frame element coupled with at least one of the first electrode and the second electrode; and
an electrically-conductive ignition aid coupled with the electrically-conductive frame element, the electrically-conductive ignition aid comprising a first extension member in contact with the first leg element and having an inner peripheral edge proximate the outer surface of the discharge element and extending in a direction along the longitudinal axis, wherein the peripheral edge is spaced radially apart from the longitudinal axis to form a gap with the outer surface of the discharge element.

2. The lamp of claim 1, wherein the first extension member comprises a first contact and a second contact, and wherein at least one of the first contact and the second contact couples with the first leg element.

3. The lamp of claim 2, wherein the first contact and the second contact couples with the first leg element at, respectively, a first contact area and a second contact area that is different from the first contact area.

4. The lamp of claim 2, further comprising a material layer disposed on the first leg element.

5. The lamp of claim 4, wherein the material layer comprises a conductive coating.

6. The lamp of claim 1, wherein the extension member comprises a second extension member in contact with a second leg element that extends from a side of the discharge element opposite the first leg element.

7. The lamp of claim 6, further comprising a weld securing the electrically-conductive ignition aid to the frame element.

8. The lamp of claim 1, wherein the peripheral edge is parallel to the outer surface of the discharge element.

9. The lamp of claim 1, wherein the electrically-conductive ignition aid comprises material with a melting point of 500° C. or greater.

10. The lamp of claim 1, wherein the peripheral edge extends at least half the length of the discharge element as measured along the longitudinal axis.

11. A high-intensity discharge lamp, comprising:
an electrically-insulating arctube comprising light transmitting material, the electrically insulating arctube having a longitudinal axis and a discharge element with a first leg element and a second leg element extending on opposite sides of the discharge element;
a plurality of electrodes comprising a first electrode and a second electrode extending into, respectively, the first leg element and the second leg element;
an electrically-conductive frame element coupled with at least one of the first electrode and the second electrode; and
an electrically-conductive ignition aid coupled to the electrically-conductive frame element, the ignition aid comprising an elongated body member and a first extension member and a second extension member extending from the elongated body member toward the longitudinal axis to contact the arctube at, respectively, the first leg element and the second leg element, the elongated body member having a peripheral edge extending in a direction along the longitudinal axis,
wherein the peripheral edge is spaced radially apart from the longitudinal axis to form a gap between the peripheral edge and a surface of the arctube, the gap having a size effective to cause a charge channel to form along an inner surface of the discharge element.

12. The high-intensity discharge lamp of claim 11, further comprising an outer jacket and a socket that couples with the outer jacket to form a hermetically-sealed cavity about the electrically-conductive ignition aid and the electrically-insulating arctube.

13. The high-intensity discharge lamp of claim 11, wherein the first extension member and the second extension member comprises a pair of contacts that generate a clamping force on the first leg element and the second leg element.

14. The high-intensity discharge lamp of claim 13, wherein the pair of contacts contact the first leg element and the second leg element at a first contact area and a second contact area that is different from the first contact area.

15. The high-intensity discharge lamp of claim 11, wherein the peripheral edge is parallel to the surface.

16. (canceled)

17. (canceled)

18. (canceled)

19. (canceled)

20. (canceled)

21. A lamp, comprising:
an arctube having a longitudinal axis, a discharge element with an outer surface, and a first leg element extending from the discharge element along the longitudinal axis and a second leg element that extends from a side of the discharge element opposite the first leg element;
a plurality of electrodes comprising a first electrode and a second electrode extending into the arctube;
an electrically-conductive frame element coupled with at least one of the first electrode and the second electrode; and
an electrically-conductive ignition aid coupled with the electrically-conductive frame element, the electrically-conductive ignition aid comprising a first extension member in contact with the first leg element, the ignition aid further comprising a second extension member in contact with the second leg element,
the ignition aid having an inner peripheral edge proximate the outer surface of the discharge element and extending in a direction along the longitudinal axis, wherein the inner peripheral edge extends at least half the length of the discharge element as measured along the longitudinal axis, and
wherein the inner peripheral edge is spaced radially apart from the longitudinal axis to form a gap with the outer surface of the discharge element, the gap defining a distance from about 0.1 mm to about 1 mm.

22. The lamp of claim 21, further comprising a material layer comprising a conductive coating disposed on at least the first leg element.

23. The lamp of claim 21, wherein the peripheral edge is parallel to the outer surface of the discharge element.
